(19) United States
(12) Patent Application Publication
(10) Pub. No.: US 2020/0132340 A1
(43) Pub. Date: Apr. 30, 2020

(54) METHOD OF ACCUMULATING THERMAL ENERGY FROM DEEP EARTH

(71) Applicants: Alexey Gorbunov, Highlands Ranch, CO (US); Oleksandr Gorbunov, Kyiv (UA); Valeriy Ivanovich Gorbunov, Aurora, CO (US)

(72) Inventors: Alexey Gorbunov, Highlands Ranch, CO (US); Oleksandr Gorbunov, Kyiv (UA); Valeriy Ivanovich Gorbunov, Aurora, CO (US)

(21) Appl. No.: 16/172,859

(22) Filed: Oct. 29, 2018

(51) Int. Cl. F24T 10/30; F24T 10/20; F24S 10/80

(52) U.S. Cl. CPC F24T 10/30; F24S 10/80; F24T 10/20

(57) ABSTRACT

A new method of accumulating thermal energy in the bowels of the Earth to ensure stable, continuous operation of a solar thermal power plant.

The solution of underground storage of heat will be useful for:
Expansion of the solar thermal energy geography.
Extension of the scope of existing geothermal technologies.
Combining the mutual interests of energy-generating and oil-and-gas companies on the platform of new opportunities for using advanced technologies of each other.

### BACKGROUND OF THE INVENTION

The present invention relates to the thermal generation of electrical energy. More particularly, the present invention is in the field of technical solutions of the accumulation of heat to ensure continuous operation of solar thermal power units during the period when the Solar activity is not enough or absent.

The first solutions in this area are associated with the use of geological formations for underground gas storage. These storage facilities are essential elements in ensuring the stable operation of powerful gas transmission systems. The world's first pilot gas injection into a depleted gas field was carried out in Canada in 1915 (the Welland County deposit). The first industrial gas storage facility with a capacity of 62 million m³ was created in 1916 in the USA (the Zoar gas field near Buffalo, N.Y.) [1].

For the arrangement of underground gas storage facilities mainly are used the depleted gas fields because the natural reservoir has high reliability in the sense of tightness of the storage at high gas pressures.

At the same time, for underground gas storage, other types of geological formations were developed and tested in industrial conditions. It has been found advantageous to store gas in a water-hearing porous rock, commonly called an “aquifer”. Such aquifers are more widespread than gas fields. They serve as satisfactory underground reservoirs because in many instances they may possess all the structural features of a conventional hydrocarbon trap without however having any natural hydrocarbons [2].

The increase in the reliability of the storage tank of gas under the ground is provided by solutions for additional sealing of the working volume and maintenance of the necessary thermo-baric conditions in the storage. For example, in [3] the system includes a plurality of underground storage containers, each one is an elongated (e.g., 100 feet) string of conventional oil field casing sealed at both ends and positioned in a special borehole. R. L. Loofbourow [4] suggests storing natural gas underground at near-critical temperatures and pressures. Because gas is stored in a dense, subcooled, yet still gaseous state, no large plants (liquefaction or vaporizer) are needed. Storage requires minimal surface area and can be located near the consumer. More complex schemes of underground gas storage include its dissolution in a hydrocarbon fluid [5] or special mine workings in the salt layer [6]. The underground storage segment has been developing in the gas industry for more than 100 years. Many fundamental technical solutions were obtained for injection and withdrawal cycles realization of huge volumes of natural gas. Technical means, methods, and technologies are constantly being improved (https://patents.justia.com/patents-by-us-classification/62/53. Underground Or Underwater Storage Patents {Class 62/53.1}—44 articles).

The second large industrial segment, which is oriented to the underground storage of liquid substances in large volumes, is the disposal of waste. Various methods for underground disposal of industrial wastes are known. The most famous of them are: pumping sewage into deep aquifers; burial of waste in artificially created containers in weakly permeable clay and salt-bearing rocks by means of mechanical excavation of rocks, hydraulic fracturing of the reservoir, underground explosions, dissolution of salt, etc.; burial in friable rocks of the aeration zone of high power due to the use of sorption capacity of rocks; burial in waste mines; use of certain types of wastewater in the system of water flooding on oil reservoirs. It is supposed injection of different solutions and suspensions under various hydrodynamic conditions of the storage, including for the permeable strata having original fluid pressure in the pores which is less than normal hydrostatic pressure [7-9].

Finally, industrial technologies are known for pumping large volumes of superheated water with a temperature above the boiling point at the underground sulfur mining by the smelting process [10-12].

Thus, in the oil and gas as well as in the mining industries the perfective equipment, tools and technologies for accumulation of the thermal agent large volumes into subsurface geological structure were created.

### SUMMARY OF THE INVENTION

The method of accumulating thermal energy to ensure the stable and continuous operation of a solar thermal power plant during the period when the Solar activity is not enough or absent. To accumulate a thermal agent (the liquid overheated above 330 degrees' Celsius) is proposed to use the empty gas field or a similar geological formation. In the oil and gas industry are using the spectrum of water flooding technologies with a full set of necessary technical means and methodical solutions. Because the heat capacity of water is relatively high as well as the thermal conductivity of rocks is relatively low, it is expected that heat losses in the steady state of the thermal agent circulation will not be significant. Taking into account the huge capacity of natural underground reservoirs, such scheme will ensure the accumulation of the mass of superheated water necessary for the operation of a thermal power plant of almost arbitrary power.

The main difference between the proposed method and existing ones is the use of a complex of technologies for managing reservoir properties as well as the fluid hydrodynamic characteristics which are advanced in the oil and gas industry, including directional fracturing; waterproofing of reservoir zones; the external water inject for maintaining reservoir pressure. Due to this, optimal costs for pumping down and production of the thermal agent necessary volumes are achieved.

### BRIEF DESCRIPTION OF THE DRAWINGS

FIG. 1 The general scheme of underground thermal agent accumulation.

FIG. 2. Dynamic of the injection and withdrawal streams

FIG. 3. The main components of the design and the primary technology elements underground storage of the thermal agent.

FIG. 4. The key phases of construction and operation of the storage.

FIG. 5. The model of 2D temperature distribution over time (rectangular plate).

FIG. 6. The model of 3D temperature distribution over time (cylindrical cavity).

FIG. 7. Temperature distribution within the underground storage model.

### DETAILED DESCRIPTION OF THE INVENTION

Referring now to the invention in more detail.

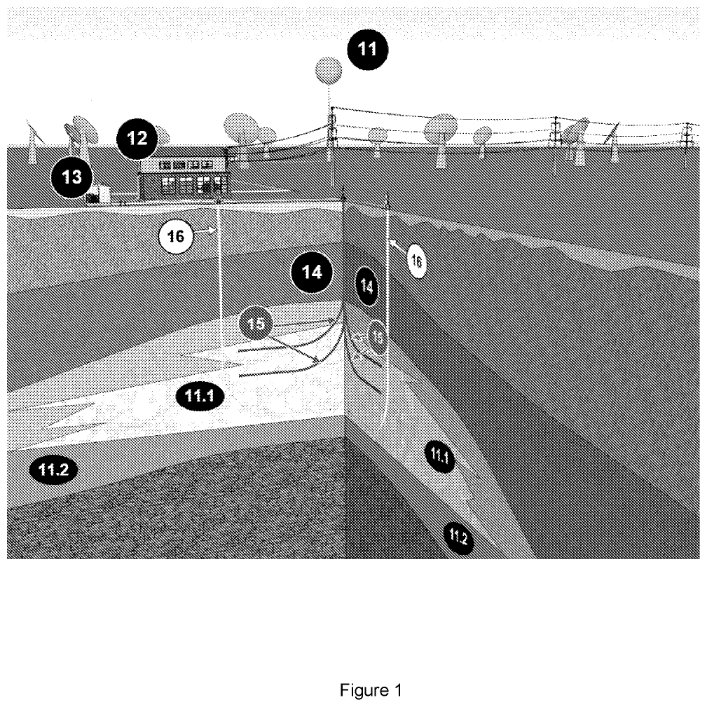

FIG. 1 shows the general scheme of the underground storage of the thermal agent. This storage similarly as the well-known gas storage facilities in natural reservoirs ensures continuous and uniform operation of the system. The system, in this case, consists of a complex of heat-producing equipment 11, a power unit 12, the pump-compressor equipment 13. Within the subsurface geological massif 14, with the use of technologies of hydraulic fracturing and waterproofing, two zones are formed. Zone of the rocks high permeability 11.1 and low permeability zone 11.2. Zone 11.1 is the active element in which the flows of thermal agent and buffer water are circulated (injection and withdrawal). Each flow is through separate contours of the wells 15 and 16 respectively.

To keep the formation pressure stable, the agent injection cycle through the contour 15 is accompanied by the withdrawing of the buffer water through the contour (16) from the peripheral part of the active zone 11.1. Conversely, during the withdrawing of the agent through the contour 15, water is injected through the contour 16.

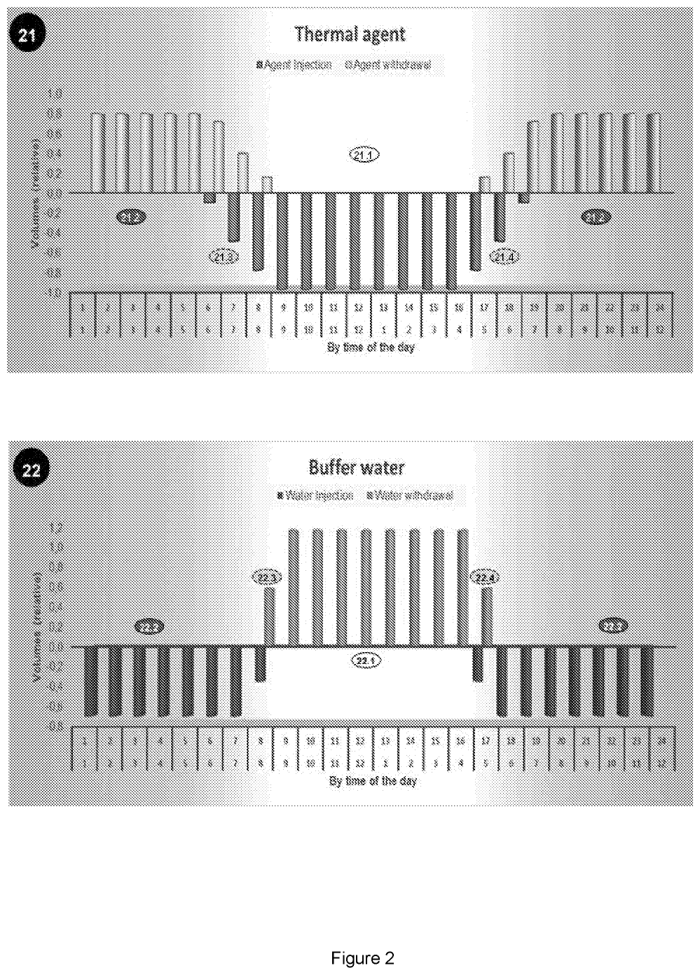

FIG. 2 shows in graphs the balance of thermal agent 21 and buffer water 22 flows. In its turn, this balance determined the functionality of the proposed underground storage of the thermal agent. The Daytime work cycle 21.1, 22.1 provides the injection of a thermal agent and the withdrawal of a buffer water to equivalent volumes. Nighttime work cycle 21.2, 22.2 provides the withdrawal of a thermal agent and the injection of a buffer water. To ensure continuous operation of the storage facility, during the transition from cycle to cycle, agent and water flow circulate in both directions—periods 21.3, 22.3 and 21.4, 22.4 respectively. The intensity of the flows is gradually changing. The intensity of the flows is gradually changing. Practically the cycles of thermal agent injection and withdrawal duration is determined by the particular periodicity of solar activity. Thus, the stability of the hydrodynamic conditions in the storage facility is ensured.

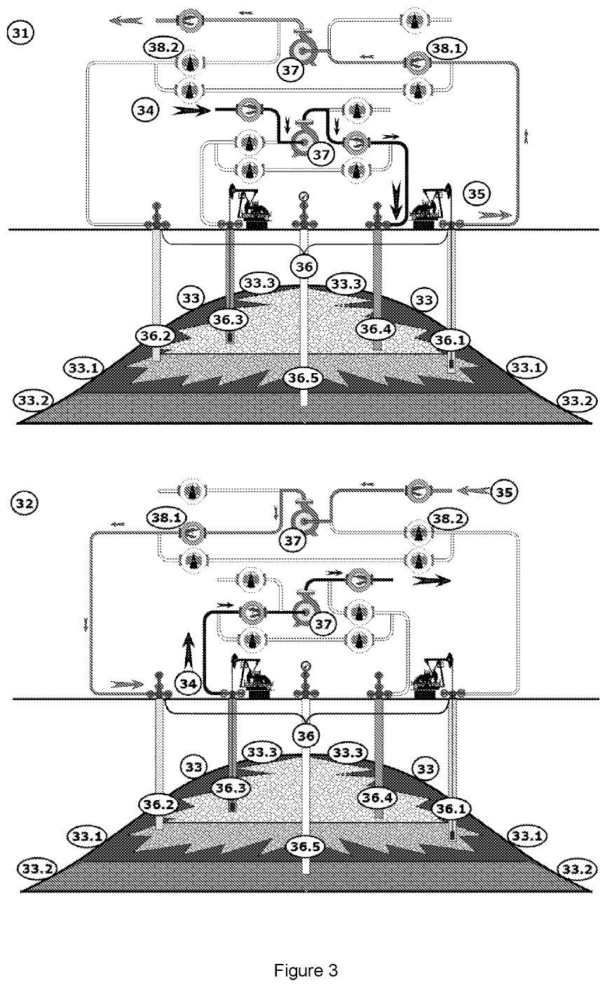

Important details of the proposed method underground storage of the thermal agent are refining on FIG. 3. It displays the simplified model of the storage in two facility operation modes. In the agent injection mode (day cycle) 31 and in the agent withdrawal mode (night cycle) 32. The natural reservoir 33 is a localized volume of porous and permeable rocks that is bounded by covering stratum 33.1 and underlying stratum 33.2 which are impermeable. Perhaps in the lower part additionally to shielded in zone 33.3 with the help of special means of the formation waterproofing. On the contrary, the active water exchange zone 33.3 can be broken by high-power hydraulic fracturing to increase its natural permeability.

In the daytime cycle 31, the flow of the thermal agent (superheated water) 34 is directed from the “exit” of the heat-producing equipment to the storage facility. In the nighttime cycle 32, the stream 34 is directed from the storage to the “input” of the power unit. The buffer water stream 35 is designed to maintain formation pressure in the reservoir. In the daytime cycle 31, the flow 35 is directed from the storage to the “input” of the heat-producing equipment. In the nighttime cycle 32 from the “exit” of the power unit in the storage. The circulation of the streams is maintained by a system of wells 36 through a complex of high-pressure pumps 37 and manifolds 38. The wells field includes a thermal agent supply contour (producing wells 36.1, injection wells 36.2), a buffer water supply contour (producing wells 36.3, injection wells 36.4); observation wells 36.5 (designed to the reservoir conditions control). FIG. 3 shows only an approximate scheme. In case of real project implementation, the wells technological designation and their number are determined by the technical conditions and characteristics of the geological unit, which is chosen as a storage of the thermal agent. For example, in a well-shielded, high permeable layer, the well can be used to agent injection and to agent production the same time.

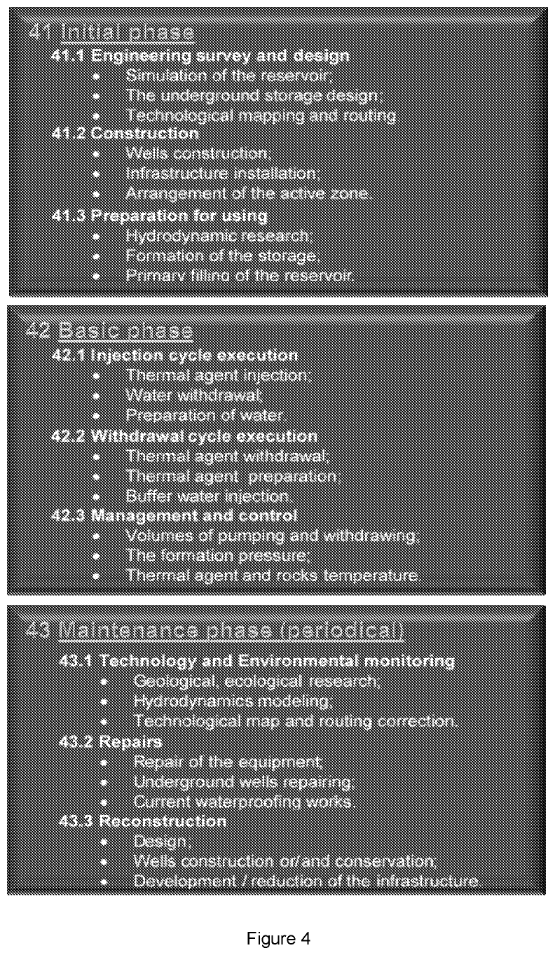

Implementation of the proposed method for storing the thermal agent requires the application of a set of technical solutions in a sequence that is determined by the practice of similar projects for underground storage of liquid substances in large volumes. The basic elements of this sequence are showing on the FIG. 4.

In the initial phase 41, the key problem is the correct engineering support of the storage facility design (stage 41.1), which is currently performed with the geological objects simulation (oil and gas fields, underground gas storage facilities, etc.). Consideration of the engineering solutions variants on the simulator allows minimizing the risks of errors at the design stage of the plants, units and corresponding technological scheme. Construction stage 41.2 along with the development of above-ground and underground production infrastructure, involves the implementation of large volumes of work on fracturing and waterproofing of the formation in the storage facility active zone. This significantly increases the cost of capital construction. However, improving the filtration properties in the aforementioned zone, taking into account the long terms of subsequent storage operation (from the experience of underground gas storage facilities), compensates for these losses due to increased productivity and reduced energy intensity of the production infrastructure.

At the final stage 41.3, of the initial phase, studies are carried out on the actual hydrodynamics of the circulation of streams in the storage facility, adjustment of equipment, including automation devices, as well as primary filling of the reservoir. First of all, the establishment of the required temperature regime in the storage facility. In the main phase of operation 42 in the underground storage of a thermal agent, the following is performed the injection cycle of the agent (superheated water) 42.1 and the agent withdrawal cycle 42.2. In the injection cycle, equivalent volumes of buffer water are also withdrawn. Also, the equivalent volumes of buffer water are injected in the withdrawal cycle. Preparation procedures of the appropriate fluid involve its purification from mechanical and gas impurities that may be contained in the formation and washed out by the flow of liquid. Also, the main phase is accompanied by actions to control and manage the flows (stage 42.3).

Stable and safe operation of the underground storage system requires permanent maintenance (phase 43).

The monitoring stage 43.1 includes:
Monitoring of the state of the geological object
Monitoring of the hydrodynamic characteristics of the system
Monitoring of the technological indicators of the storage operation.

Planned repairs, as well as underground repairing of the wells at stage 43.2, allows avoiding emergency situations and maintain the system's performance at a given level.

Finally, the reconstruction of the operating infrastructure of the underground storage facility (stage 43.3) of the thermal agent provides that its performance corresponds to the need to expand or reduce storage volumes as well as the flows circulation rates depending on the production conditions.

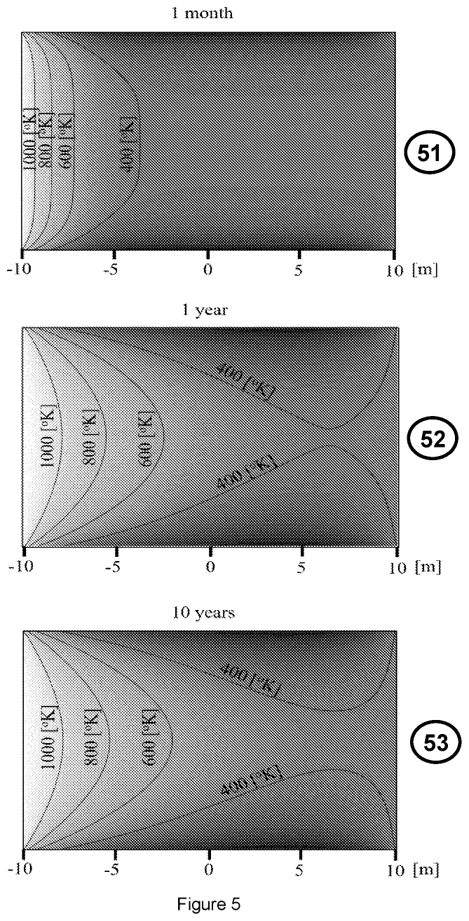

One of the key issues of the appropriateness of the underground storage of the heat-agent is to minimize the loss of the energy. FIGS. 5-7 show the results of digital modeling of the heat transfer process in a rock. The following averaged rocks characteristics had been using:
Density 2500 [kg/m³]
Heat capacity 0.835 [kJ/(kg*K)]
Thermal conductivity 2.56 [w/(m*K)]

FIG. 5 illustrates the 2D temperature distribution over time when the left face of a flat plate is heated to a temperature of 1000 degrees Kelvin. In this case, the dynamics of heat propagation in the rock massif is modeled. The 400 degree isotherm can be identified as the heating front line which have move from the left face of the plate.

Within 30 days (position 51) heat penetrates a distance of about 6 meters. During a year (position 52), this distance increases to 20 meters. Then the process is stabilized and for 10 years (position 53), the picture does not change significantly.

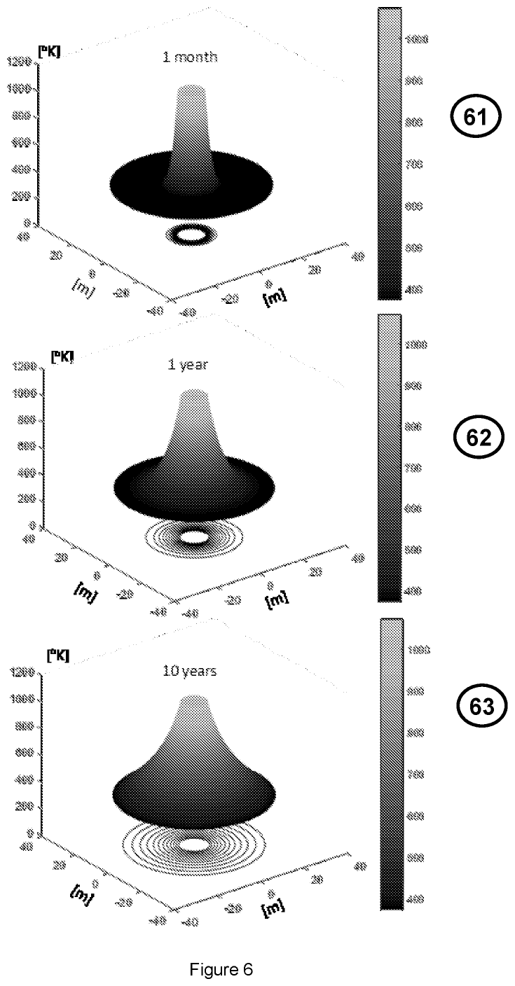

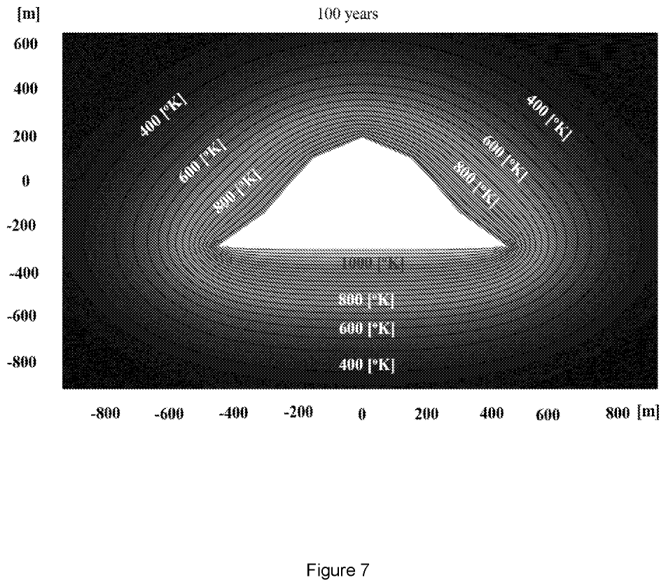

FIG. 6 shows the spatial distribution of temperatures around a cylindrical cavity heated to a specified temperature. For this model, the heating front has the form of an expanding cylinder. During the month (61), the diameter of the vertical cylindrical surface of the isotherm 400 degrees increases from 10 to 24 meters. For 1 year (62), it is already about 40 meters and in 10 years it reaches a value of almost 100 meters. Finally, FIG. 7 displays the heat-agent reservoir section and temperature distribution in the rock during of 100 years, if the temperature in the storage is maintained constant, equal to 1000 degrees Kelvin. Within this period along with an isotherm 400 K, the rock is warming up to a distance of about 500 meters.

The United States contains vast, sparsely-populated desert and semi-desert regions with sufficient access to rapidly build out the industrial and transport infrastructure of solar thermal power plants including anunderground thermal storage. Additionally, most advanced technologies and equipment for solar and geothermal energy as well as oil and mining technologies are being developed in the USA, favoring inter-industry partnerships for the successful realization of this new, renewable energy sources.

The low thermal conductivity of the rocks is a significant problem for the implementation of schemes for the forced (human-made) circulation of energy-substance when developing sources of geothermal energy. In case of underground heat storage, this is a positive factor to provide volumes of thermal agent which necessary to extend the cycle of stable operation of the solar thermal power plant.

The large capacity of underground storage facilities given the low thermal conductivities of the surrounding rocks ensures the permanent accumulation of arbitrary large heat-agent volumes. It opens up possibilities for stabilizing the work of the energy-generating infrastructure in longer than daily cycles. Thus arise the real opportunities arise for the development of solar thermal energy technologies in areas with less stable solar activity than in deserts. It is essential both for the conditions of significant differences in the length of day and night in the subpolar regions, as well as for areas with changeable weather.

The present invention reveals the new opportunities for the solar thermal power generating infrastructure development, particularly for the uninterrupted thermal agent supplying in long-duration cycles using known technologies of influence on the natural liquid mineral fields properties.

### REFERENCES

1. The value of underground gas storage in today's natural gas industry: Washington Energy Information Administration, Office of oil and gas, U.S. Department of Energy.—March 1995.
2. Malcolm R. J. Wyllie UNDERGROUND GAS STORAGE PROCESS
3. Gregory L. Brooks, Larry W. Zimmer, Allan B. Fullerton, Raymond L. Morris UNDERGROUND COMPRESSED NATURAL GAS STORAGE AND SERVICE SYSTEM
U.S. Pat. No. 5,207,530 A, Priority date Jul. 29, 1992.
4. R. Loofbourow STORAGE OF GAS IN UNDERGROUND EXCAVATION
U.S. Pat. No. 3,848,427 A, Priority date Mar. 1, 1971.
5. Kuhne G UNDERGROUND STORAGE OF GAS
U.S. Pat. No. 3,807,181 A, Priority date May 29, 2071.
6. Ross K. Hill, Paul J. UNDERGROUND GAS STORAGE WITH SHORT TERM REVERSIBLE FLOW OPERABLE FOR USE IN ARBITRAGE/TRADING
U.S. Pat. No. 7,729,976 B2, Priority date May 25, 2001.
7. John S. Bradley FLUID WASTE DISPOSAL,
U.S. Pat. No. 4,560,503 A, Priority date Aug. 30, 1982.
8. Winton G. Aubert, Edward Malachosky, Thomas K. Perkins SUBTERRANEAN DISPOSAL OF LIQUID AND SLURRIED SOLIDS WASTES,
U.S. Pat. No. 5,405,224 A, Priority date Jan. 25, 1993.
9. Albert H. D. Alexander, W. Thomas Ballatine, Leland D. Lakey, Frank L. Lyon, Stephen A. Marinello, METHOD AND APPARATUS FOR THE INJECTION DISPOSAL OF SOLID AND LIQUID WASTE MATERIALS INTO SUBPRESSURED EARTH FORMATIONS PENETRATED BY A BOREHOLE,
U.S. Pat. No. 5,734,988 A, Priority date Aug. 22, 1994.
10. Herman Frasch Mining sulfur.
U.S. Pat. No. 988,995 A, Priority date 30 Oct. 1903.
11. Randol W. Bradford, Michael H. Carmichael, SULFUR MINE BLEED WATER REUSE SYSTEM,
U.S. Pat. No. 4,241,953 A, Priority date Apr. 23, 1979.
12. John R. Peters, Max E. Ramey, Arturo E. Seyffert, Jack L. Canon, Michael W. Robinson, William T., APPARATUS FOR RECOVERY OF SULFUR,
U.S. Pat. No. 4,869,555 A, Priority date Jan. 6, 1988.

What is claimed is:

1. A method of underground storage of a thermal agent in a natural reservoir characterized in that in order to provide the continuous and uniform operation of a solar thermal power unit in a multi-day mode, as well as to ensure the necessary volumes and optimize the costs for maintaining of the thermal agent stream continually, capacitive-filtration properties of the reservoir improve by directional fracturing.

2. A method of claim 1, characterized in that to restrict of water inflow from peripheral zones of reservoir sections use the waterproofing technologies.

3. A method of claim 1, 2 characterized in that to the maintaining reservoir pressure the spent thermal agent after exiting the power generator turbine, is pumped into the external zone of the storage.
